(19) United States
(12) Patent Application Publication
(10) Pub. No.: US 2026/0362513 A1
(43) Pub. Date: Nov. 12, 2026

(54) METHODS AND APPARATUSES FOR POSITIONING OF TERMINAL DEVICE

(71) Applicant: Telefonaktiebolaget LM Ericsson (publ), Stockholm (SE)

(72) Inventors: Ritesh SHREEVASTAV, Upplands Väsby (SE); Xiaolin JIANG, Linköping (SE); Gustav LINDMARK, Linköping (SE); Fredrik GUNNARSSON, Linköping (SE)

(73) Assignee: Telefonaktiebolaget LM Ericsson (publ), Stockholm (SE)

(21) Appl. No.: 19/155,828

(22) PCT Filed: Feb. 9, 2024
(86) PCT No.: PCT/CN2024/077106

§ 371 Date: Aug. 12, 2025

(30) Foreign Application Priority Data
Feb. 16, 2023 (WO) PCT/CN2023/076608

(51) Int. Cl. H04W 76/11; H04W 4/02; H04W 76/14

(52) U.S. Cl. CPC H04W 76/11; H04W 4/023; H04W 76/14

(57) ABSTRACT

Methods and apparatuses for positioning of terminal device are disclosed. According to an embodiment, a location server determines, for one of one or more target terminal devices, a session identifier (ID) for identifying a sidelink ranging/positioning session between the one or more target terminal devices, one or more reference terminal devices and the location server, and/or transaction IDs related to the sidelink ranging/positioning session. The location server sends the session ID and/or transaction IDs to the one of the one or more target terminal devices.

### CROSS-REFERENCE TO RELATED APPLICATIONS

This application is a 35 U.S.C. § 371 National Stage of International Patent Application No. PCT/CN2024/077106, filed 2014 Feb. 9, which claims priority to International Patent Application No. PCT/CN2023/076608, filed Feb. 16, 2023, which is incorporated by this reference.

### TECHNICAL FIELD

Embodiments of the disclosure generally relate to communication, and, more particularly, to methods and apparatuses for positioning of terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

FIG. 1 illustrates an exemplary overall architecture for user equipment (UE) positioning applicable to next generation radio access network (NG-RAN). As shown, the architecture comprises a UE, a next generation radio access network (NG-RAN), an access and mobility management function (AMF) and a location management function (LMF). The NG-RAN may comprise a next generation node B (gNB) and a next generation evolved node B (ng-eNB). The architecture may optionally comprise an evolved serving mobile location center (E-SMLC) and SUPL location platform (SLP). The term SUPL refers to secure user plane location.

There are following types of location requests. The first type is network induced location request (NI-LR). With an NI-LR, a serving AMF for a UE initiates localization of the UE for a regulatory service (e.g. an emergency call from the UE) or for verification of a UE location (country or international area) for new radio (NR) satellite access.

The second type is mobile terminated location request (MT-LR). With an MT-LR, a location service (LCS) client or application function (AF) external to or internal to a serving public land mobile network (PLMN) sends a location request to the PLMN (which may be the home PLMN (HPLMN) or visited PLMN (VPLMN)) for the location of a target UE.

The third type is mobile originated location request (MO-LR). With an MO-LR, a UE sends a request to a serving PLMN for location related information for the UE. The fourth type is immediate location request. With an immediate location request, an LCS client or AF sends or instigates a location request for a target UE (or group of target UEs) and expects to receive a response containing location information for the target UE (or group of target UEs) within a short time period which may be specified using quality of service (QoS). An immediate location request may be used for an NI-LR, MT-LR or MO-LR.

The fifth type is deferred location request. With a deferred location request, an LCS client or AF sends a location request to a PLMN for a target UE (or group of target UEs) and expects to receive a response containing the indication of event occurrence and location information if requested for the target UE (or group of target UEs) at some future time (or times), which may be associated with specific events associated with the target UE (or group of target UEs). In this version of the specification, only deferred location requests for an MT-LR are supported.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for positioning of terminal device. In particular, one of the problems to be solved by the disclosure is that the existing long term evolution (LTE) positioning protocol (LPP) session definition could not support ranging/sidelink positioning sessions or hybrid positioning sessions.

According to a first aspect of the disclosure, there is provided a method performed by a location server. The method may comprise determining, for one of one or more target terminal devices, a session identifier (ID) for identifying a sidelink ranging/positioning session between the one or more target terminal devices, one or more reference terminal devices and the location server, and/or transaction IDs related to the sidelink ranging/positioning session. The method may further comprise sending the session ID and/or transaction IDs to the one of the one or more target terminal devices.

In this way, it is possible to allow the location server to support a sidelink ranging/positioning session.

According to a second aspect of the disclosure, there is provided a method performed by a target terminal device in one or more target terminal devices. The method may comprise determining a session ID for identifying a sidelink ranging/positioning session between the one or more target terminal devices, one or more reference terminal devices and a location server, and/or transaction IDs related to the sidelink ranging/positioning session. The method may further comprise sending the session ID and/or transaction IDs to one or more other participants in the sidelink ranging/positioning session.

In this way, it is possible to allow the target terminal device to support a sidelink ranging/positioning session.

According to a third aspect of the disclosure, there is provided a method performed by a location server. The method may comprise maintaining a correlation between first session IDs identifying first sessions and at least one second session ID identifying at least one second session. The at least one second session may be sidelink ranging/positioning session between at least one target terminal device and at least one reference terminal device, and the first sessions may be used for RAT dependent positioning of the at least one target terminal device and the at least one reference terminal device. The method may further comprise sending, to the at least one target terminal device and the at least one reference terminal device, measurement requests for obtaining both first measurement and second measurement, based on the maintained correlation. The first measurement may be RAT dependent measurement for positioning, and the second measurement may be sidelink measurement for ranging/positioning. The method may further comprise receiving measurement reports from the at least one target terminal device and the at least one reference terminal device. The method may further comprise determining a positioning result for the at least one target terminal device, based on the received measurement reports.

In this way, it is possible to allow the location server to improve positioning accuracy with a hybrid session.

According to a fourth aspect of the disclosure, there is provided a method performed by a location server. The method may comprise using a same session ID for first sessions and at least one second session. The at least one second session may be sidelink ranging/positioning session between at least one target terminal device and at least one reference terminal device, and the first sessions may be used for RAT dependent positioning of the at least one target terminal device and the at least one reference terminal device. The method may further comprise sending, to the at least one target terminal device and the at least one reference terminal device, measurement requests for obtaining both first measurement and second measurement, based on the same session ID. The first measurement may be RAT dependent measurement for positioning, and the second measurement may be sidelink measurement for ranging/positioning. The method may further comprise receiving measurement reports from the at least one target terminal device and the at least one reference terminal device. The method may further comprise determining a positioning result for the at least one target terminal device, based on the received measurement reports.

In this way, it is possible to allow the location server to improve positioning accuracy with a hybrid session.

According to a fifth aspect of the disclosure, there is provided a location server. The location server may comprise at least one processor and at least one memory. The at least one memory may contain instructions executable by the at least one processor, whereby the location server may be operative to determine, for one of one or more target terminal devices, a session ID for identifying a sidelink ranging/positioning session between the one or more target terminal devices, one or more reference terminal devices and the location server, and/or transaction IDs related to the sidelink ranging/positioning session. The location server may be further operative to send the session ID and/or transaction IDs to the one of the one or more target terminal devices.

In an embodiment of the disclosure, the location server may be operative to perform the method according to the above first aspect.

According to a sixth aspect of the disclosure, there is provided a target terminal device in one or more target terminal devices. The target terminal device may comprise at least one processor and at least one memory. The at least one memory may contain instructions executable by the at least one processor, whereby the target terminal device may be operative to determine a session ID for identifying a sidelink ranging/positioning session between the one or more target terminal devices, one or more reference terminal devices and a location server, and/or transaction IDs related to the sidelink ranging/positioning session. The target terminal device may be further operative to send the session ID and/or transaction IDs to one or more other participants in the sidelink ranging/positioning session.

In an embodiment of the disclosure, the target terminal device may be operative to perform the method according to the above second aspect.

According to a seventh aspect of the disclosure, there is provided a location server. The location server may comprise at least one processor and at least one memory. The at least one memory may contain instructions executable by the at least one processor, whereby the location server may be operative to maintain a correlation between first session IDs identifying first sessions and at least one second session ID identifying at least one second session. The at least one second session may be sidelink ranging/positioning session between at least one target terminal device and at least one reference terminal device, and the first sessions may be used for RAT dependent positioning of the at least one target terminal device and the at least one reference terminal device. The location server may be further operative to send, to the at least one target terminal device and the at least one reference terminal device, measurement requests for obtaining both first measurement and second measurement, based on the maintained correlation. The first measurement may be RAT dependent measurement for positioning, and the second measurement may be sidelink measurement for ranging/positioning. The location server may be further operative to receive measurement reports from the at least one target terminal device and the at least one reference terminal device. The location server may be further operative to determine a positioning result for the at least one target terminal device, based on the received measurement reports.

In an embodiment of the disclosure, the location server may be operative to perform the method according to the above third aspect.

According to an eighth aspect of the disclosure, there is provided a location server. The location server may comprise at least one processor and at least one memory. The at least one memory may contain instructions executable by the at least one processor, whereby the location server may be operative to use a same session ID for first sessions and at least one second session. The at least one second session may be sidelink ranging/positioning session between at least one target terminal device and at least one reference terminal device, and the first sessions may be used for RAT dependent positioning of the at least one target terminal device and the at least one reference terminal device. The location server may be further operative to send, to the at least one target terminal device and the at least one reference terminal device, measurement requests for obtaining both first measurement and second measurement, based on the same session ID. The first measurement may be RAT dependent measurement for positioning, and the second measurement may be sidelink measurement for ranging/positioning. The location server may be further operative to receive measurement reports from the at least one target terminal device and the at least one reference terminal device. The location server may be further operative to determine a positioning result for the at least one target terminal device, based on the received measurement reports.

In an embodiment of the disclosure, the location server may be operative to perform the method according to the above fourth aspect.

According to a ninth aspect of the disclosure, there is provided a computer program product. The computer program product may comprise instructions which when executed by at least one processor, cause the at least one processor to perform the method according to any of the above first to fourth aspects.

According to a tenth aspect of the disclosure, there is provided a computer readable storage medium. The computer readable storage medium may store thereon instructions which when executed by at least one processor, cause the at least one processor to perform the method according to any of the above first to fourth aspects.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an exemplary architecture for UE positioning;

FIG. 2 is a diagram illustrating different scenarios of UE operations;

FIG. 3 is a flowchart illustrating a method performed by a location server according to an embodiment of the disclosure;

FIG. 4 is a flowchart illustrating a method performed by a location server according to an embodiment of the disclosure;

FIG. 5 is a flowchart illustrating a method performed by a location server according to an embodiment of the disclosure;

FIG. 6 is a flowchart illustrating a method performed by a target terminal device according to an embodiment of the disclosure;

FIG. 7 is a flowchart illustrating a method performed by a target terminal device according to an embodiment of the disclosure;

FIG. 8 is a flowchart illustrating a method performed by a location server according to an embodiment of the disclosure;

FIG. 9 is a flowchart illustrating a method performed by a location server according to an embodiment of the disclosure;

FIG. 10 is a flowchart illustrating a method performed by a location server according to an embodiment of the disclosure;

FIG. 11 is a flowchart illustrating a method performed by a location server according to an embodiment of the disclosure;

FIG. 12 is a flowchart illustrating a method performed by a location server according to an embodiment of the disclosure;

FIG. 13 is a flowchart illustrating a method performed by a location server according to an embodiment of the disclosure;

FIG. 14 is a flowchart illustrating an exemplary process according to an embodiment of the disclosure;

FIG. 15 is a flowchart illustrating an exemplary process according to an embodiment of the disclosure;

FIG. 16 is a flowchart illustrating an exemplary process according to an embodiment of the disclosure;

FIG. 17 is a flowchart illustrating an exemplary process according to an embodiment of the disclosure;

FIGS. 18A-18B are diagrams each illustrating an option for sidelink positioning protocol (SLPP) protocol stack;

FIG. 19 is a diagram illustrating an exemplary scenario of sidelink ranging;

FIG. 20 is a flowchart illustrating an exemplary process according to an embodiment of the disclosure;

FIG. 21 is a flowchart illustrating an exemplary process according to an embodiment of the disclosure;

FIG. 22 is a block diagram showing an apparatus suitable for use in practicing some embodiments of the disclosure;

FIG. 23 is a block diagram showing a location server according to an embodiment of the disclosure;

FIG. 24 is a block diagram showing a target terminal device according to an embodiment of the disclosure;

FIG. 25 is a block diagram showing a location server according to an embodiment of the disclosure;

FIG. 26 is a block diagram showing a location server according to an embodiment of the disclosure;

FIG. 27 is diagram illustrating an example of a communication system in accordance with some embodiments;

FIG. 28 is a diagram illustrating a UE in accordance with some embodiments;

FIG. 29 is a diagram illustrating a network node in accordance with some embodiments;

FIG. 30 is a diagram illustrating a host in accordance with some embodiments;

FIG. 31 is a diagram illustrating a virtualization environment in which functions implemented by some embodiments may be virtualized; and

FIG. 32 is a diagram illustrating a host communicating via a network node with a UE over a partially wireless connection in accordance with some embodiments.

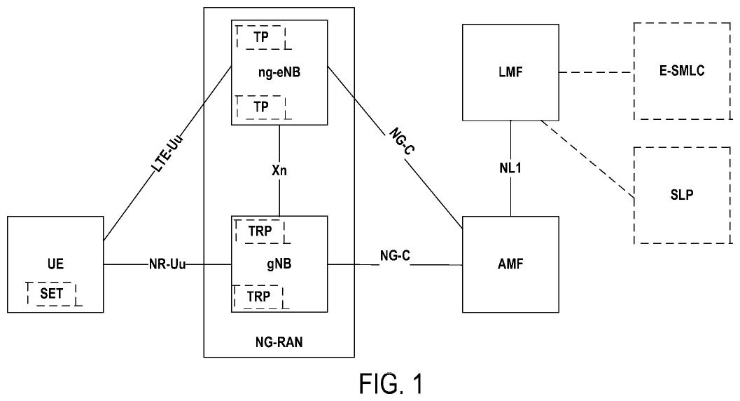

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

In the release 18 work in 3rd generation partnership project (3GPP), solutions for sidelink (SL) ranging and positioning will be studied and standardized, as outlined in the work item description (see RP-223549). Previous releases of 3GPP focused on downlink (DL) and/or uplink (UL) signals, and the DL positioning reference signal (DL PRS) and UL sounding reference signal (SRS) for positioning were specified in release 16.

NR currently supports below RAT dependent positioning methods: downlink (DL) time difference of arrival (DL-TDOA), multi round-trip time (multi-RTT), uplink (UL) time difference of arrival (UL-TDOA), DL angle of departure (DL-AoD), UL angle of arrival (UL-AoA), and new radio (NR) enhanced cell ID (NR-ECID).

The DL TDOA positioning method makes use of the DL reference signal time difference (RSTD) (and optionally DL positioning reference signal (PRS) reference signal received power (RSRP)) of downlink signals received from multiple transmission points (TPs), at the UE. The UE measures the DL RSTD (and optionally DL PRS RSRP) of the received signals using assistance data received from the positioning server, and the resulting measurements are used along with other configuration information to locate the UE in relation to the neighboring TPs.

The multi-RTT positioning method makes use of the UE reception-transmission (Rx−Tx) measurements and DL PRS RSRP of downlink signals received from multiple transmission reception points (TRPs), measured by the UE and the measured gNB Rx−Tx measurements and UL sounding reference signal RSRP (SRS-RSRP) at multiple TRPs of uplink signals transmitted from UE.

The UL TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The UL AoA positioning method makes use of the measured azimuth and zenith of arrival at multiple RPs of uplink signals transmitted from the UE. The RPs measure azimuth AoA (A-AoA) and zenith AoA (Z-AoA) of the received signals using assistance data received from the positioning server, and the resulting measurements are used along with other configuration information to estimate the location of the UE.

The NR-ECID positioning refers to techniques which use additional UE measurements and/or NR radio resource and other measurements to improve the UE location estimate.

The positioning modes can be categorized in below three areas: UE-Assisted, UE-Based, and Standalone. In UE-Assisted mode, the UE performs measurements with or without assistance from the network and sends these measurements to the E-SMLC where the position calculation may take place. In UE-Based mode, the UE performs measurements and calculates its own position with assistance from the network. In Standalone mode, the UE performs measurements and calculates its own without network assistance.

An LPP session is used between a location server and the target device in order to obtain location related measurements or a location estimate or to transfer assistance data. A single LPP session is used to support a single location request (e.g., for a single MT-LR, MO-LR or NI-LR). Multiple LPP sessions can be used between the same endpoints to support multiple different location requests (as required by technical specification (TS) 23.271). Each LPP session comprises one or more LPP transactions, with each LPP transaction performing a single operation (capability exchange, assistance data transfer, or location information transfer). In evolved universal terrestrial radio access network (E-UTRAN) and NG-RAN, the LPP transactions are realized as LPP procedures. The term UMTS refers to universal mobile telecommunications service. The instigator of an LPP session will always instigate the first LPP transaction, but subsequent transactions may be instigated by either end. LPP transactions within a session may occur serially or in parallel. LPP transactions are indicated at the LPP protocol level with a transaction ID in order to associate messages with one another (e.g., request and response). Messages within a transaction are linked by a common transaction identifier.

With respect to sidelink transmissions in NR, 3GPP specified the LTE device-to-device (D2D) technology, also known as Proximity Services (ProSe) in the Release 12 and 13 of LTE. Later in Rel. 14 and 15, LTE vehicle-to-everything (V2X) related enhancements targeting the specific characteristics of vehicular communications were specified. 3GPP had started a new work item (WI) in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services would require enhancements of the NR system and a new NR sidelink framework could help to meet the stringent requirements in terms of latency and reliability. NR V2X system also expects to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the UEs and the network (NW), including support for standalone, network-less operation.

In 3GPP Rel. 17, discussions were taken place and National Security and Public Safety (NSPS) is considered to be one important use case, which can benefit from the already developed NR sidelink features in Rel.16. Therefore, it is most likely that 3GPP will specify enhancements related to NSPS use case taking NR Rel. 16 sidelink as a baseline. Besides, in some scenarios NSPS services need to operate with partial or without NW coverage, such as indoor firefighting, forest firefighting, earthquake rescue, sea rescue, etc. where the infrastructure is (partially) destroyed or not available. Therefore, coverage extension is a crucial enabler for NSPS, for both NSPS services communicated between UE and cellular NW and that communicated between UEs over sidelink. In Rel.17, a session ID (SID) on NR sidelink relay (RP-193253) was launched which aims to further explore coverage extension for sidelink-based communication, including both UE to NW relay for cellular coverage extension and UE to UE relay for sidelink coverage extension. Now the work has proceeded to normative phase and in the WID (R2-2207129) only UE to NW relay is considered.

In the discussions and planning for NR Rel. 18, sidelink based ranging and positioning has been agreed for standardization. With ranging it in general implies that both distance and angle information about the wireless link between two devices is derived. Distance ranging is today available in other standards, e.g., institute of electrical and electronics engineers (IEEE) 802.4z, where in general, a signal exchange is taking place between two devices allowing the round-trip-time (RTT) to be calculated.

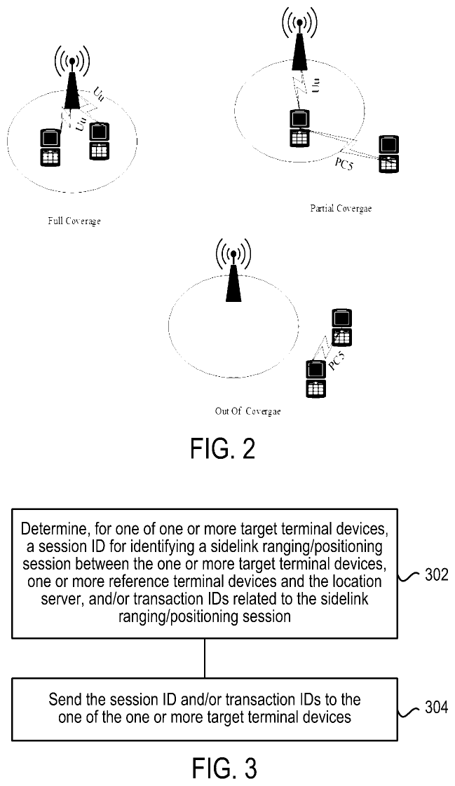

FIG. 2 illustrates different scenarios (full coverage, partial coverage and out of coverage) of UE operations. UEs that are in coverage of a gNB rely on configuration (through radio resource control (RRC) and/or system information block (SIB)). UEs that are out of coverage rely on a (pre-)configuration available in the subscriber identity module (SIM) of the device. The pre-configuration is (semi-)static. Updates are possible (when the UE is in coverage).

In this document, ranging refers to the determination of the distance between two UEs or more UEs and/or the direction of one UE (i.e. Target UE) from another UE (i.e. Reference UE) via PC5 interface. Sidelink Positioning refers to positioning UE using PC5 to obtain absolute position, relative position, or ranging information. sidelink (SL) Reference UE refers to a UE, supporting positioning of target UE, e.g., by transmitting and/or receiving reference signals for positioning, providing positioning-related information, etc., using sidelink. Target UE refers to a UE whose distance, direction and/or position is measured with the support from one or multiple SL Reference UEs using Sidelink in the Ranging based service and Sidelink positioning. SL UE server refers to a UE offering location calculation, for Sidelink Positioning and Ranging based service. It interacts with other UEs over PC5 as necessary in order to calculate the location of the Target UE. Target UE or SL Reference UE can act as SL Positioning Server UE if location calculation is supported.

A positioning reference unit (PRU) at a known location can perform positioning measurements (e.g., RSTD, RSRP, UE Rx−Tx Time Difference measurements, etc.) and report these measurements to a location server. In addition, the PRU can transmit SRS to enable TRPs to measure and report UL positioning measurements (e.g., relative time of arrival (RTOA), UL-AoA, gNB Rx−Tx Time Difference, etc.) from PRU at a known location. The PRU measurements can be compared by a location server with the measurements expected at the known PRU location to determine correction terms for other nearby target devices. The DL and/or UL location measurements for other target devices can then be corrected based on the previously determined correction terms. From a location server perspective, the PRU functionality is realized by a UE with known location.

The legacy LPP session is defined between a target UE and an LMF. However, in a sidelink positioning session, there are also reference/anchor UE(s) involved, and there are cases when two or more target UEs as a group performs ranging, e.g., for platooning. Thus ranging/sidelink positioning sessions or hybrid positioning sessions are not supported by LPP session definition.

Therefore, new session definition and identifier are needed for ranging/sidelink positioning sessions. For hybrid session, methods to associate all the measurements from the relevant UEs are needed.

The present disclosure proposes an improved solution for positioning of terminal device. The solution may be applicable to a communication system comprising a terminal device, a radio access network (RAN), an access and mobility management function (AMF) and a location management function (LMF). The functional description of the above entities can be found from clause 6 of 3GPP TS 23.501 V18.0.0.

Within the context of this disclosure, the term UE or terminal device may also be referred to as, for example, device, access terminal, mobile station, mobile unit, subscriber station, or the like. It may refer to any end device that can access a wireless communication network and receive services therefrom. By way of example and not limitation, the UE or terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a UE or terminal device may represent a machine or other device that performs monitoring and/or measurements, and transmits the results of such monitoring and/or measurements to another UE or terminal device and/or a network equipment. In this case, the UE or terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network entity (or a network function) in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

FIG. 3 is a flowchart illustrating a method performed by a location server according to an embodiment of the disclosure. The role of the location server may be implemented by an LMF, or a terminal device acting as a server for sidelink positioning (e.g. a sidelink UE server), or any other entity having similar functionality. Note that the network function (or network node) mentioned in this document may be implemented either as a network element on a dedicated hardware, as a software instance running on a dedicated hardware, or as a virtualized function instantiated on an appropriate platform, e.g. on a cloud infrastructure.

At block 302, the location server determines, for one of one or more target terminal devices, a session ID for identifying a sidelink ranging/positioning session between the one or more target terminal devices, one or more reference terminal devices and the location server, and/or transaction IDs related to the sidelink ranging/positioning session. For example, the session ID may be determined in response to an initiation of the sidelink ranging/positioning session by the location server. An unused value may be selected from a predetermined range of values (e.g. from a first predetermined integer to a second predetermined integer) to act as the session ID for the one target terminal device. Optionally, the predetermined range of values may be divided into different non-overlapping subsets each of which is mapped to a different case of the entity that collects the measurement and calculate the results. The transaction ID may be determined in a similar way. As an exemplary example, the session ID may be the same but differentiated by different ranges of the transaction IDs between sidelink operation and RAT dependent operation (e.g. Uu operation).

At block 304, the location server sends the session ID and/or transaction IDs to the one of the one or more target terminal devices. For example, the session ID and/or transaction IDs may be sent to the one of the one or more target terminal devices in a positioning request for the sidelink ranging/positioning session. The one target terminal device may then transmit the session ID and/or transaction IDs to remaining target terminal device(s) and the one or more reference terminal devices. With the method of FIG. 3, it is possible to allow the location server to support a sidelink ranging/positioning session since the novel session ID and/or transaction IDs can be used to indicate/associate the measurements from the one or more reference terminal devices and one or more target terminal devices which are within a sidelink ranging/positioning session.

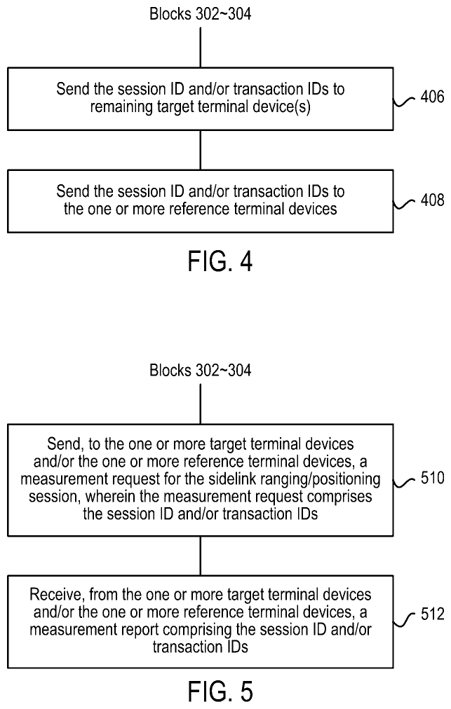

FIG. 4 is a flowchart illustrating a method performed by a location server according to an embodiment of the disclosure. The role of the location server may be implemented by an LMF, or a terminal device acting as a server for sidelink positioning (e.g. a sidelink UE server), or any other entity having similar functionality. As shown, the method comprises blocks 302-304 described above, and blocks 406-408. At block 406, the location server sends the session ID and/or transaction IDs to remaining target terminal device(s). At block 408, the location server sends the session ID and/or transaction IDs to the one or more reference terminal devices. With the method of FIG. 4, the other participants in the sidelink ranging/positioning session can obtain the session ID and/or transaction IDs. Note that since the session ID and/or transaction IDs can be forwarded to each other among the one or more target/reference terminal devices, either block 406 or block 408 may be optionally omitted from FIG. 4.

FIG. 5 is a flowchart illustrating a method performed by a location server according to an embodiment of the disclosure. The role of the location server may be implemented by an LMF, or a terminal device acting as a server for sidelink positioning (e.g. a sidelink UE server), or any other entity having similar functionality. As shown, the method comprises blocks 302-304, and blocks 510-512. At block 510, the location server sends, to the one or more target terminal devices and/or the one or more reference terminal devices, a measurement request for the sidelink ranging/positioning session. The measurement request comprises the session ID and/or transaction IDs. At block 512, the location server receives, from the one or more target terminal devices and/or the one or more reference terminal devices, a measurement report comprising the session ID and/or transaction IDs. With the method of FIG. 5, the measurements from the participants in a sidelink ranging/positioning session can be obtained since the novel session ID and/or transaction IDs can indicate/associate such measurements.

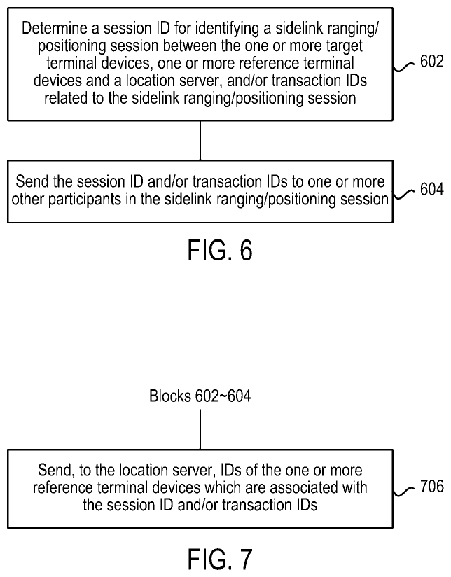

FIG. 6 is a flowchart illustrating a method performed by a target terminal device according to an embodiment of the disclosure. The target terminal device may be one of one or more target terminal devices. At block 602, the target terminal device determines a session ID for identifying a sidelink ranging/positioning session between the one or more target terminal devices, one or more reference terminal devices and a location server, and/or transaction IDs related to the sidelink ranging/positioning session. The role of the location server may be implemented by an LMF, or a terminal device acting as a server for sidelink positioning (e.g. a sidelink UE server), or any other entity having similar functionality. For example, the session ID may be determined in response to an initiation of the sidelink ranging/positioning session by the target terminal device. An unused value may be selected from a predetermined range of values (e.g. from a first predetermined integer to a second predetermined integer) to act as the session ID. Optionally, the predetermined range of values may be divided into different non-overlapping subsets each of which is mapped to a different case of the entity that collects the measurement and calculate the results. The transaction ID may be determined in a similar way. As an exemplary example, the session ID may be the same but differentiated by different ranges of the transaction IDs between sidelink operation and RAT dependent operation (e.g. Uu operation).

At block 604, the target terminal device sends the session ID and/or transaction IDs to one or more other participants in the sidelink ranging/positioning session. For example, the session ID and/or transaction IDs may be sent to the location server in a positioning request for the sidelink ranging/positioning session. The positioning request may optionally indicate one or more of: remaining target terminal device(s); and one or more potential reference terminal devices which are discovered by the target terminal device. With the method of FIG. 6, it is possible to allow the target terminal device to support a sidelink ranging/positioning session since the novel session ID and/or transaction IDs can be used to indicate/associate the measurements from the one or more reference terminal devices and one or more target terminal devices which are within a sidelink ranging/positioning session.

FIG. 7 is a flowchart illustrating a method performed by a target terminal device according to an embodiment of the disclosure. As shown, the method comprises blocks 602-604 described above, and block 706. At block 706, the target terminal device sends, to the location server, IDs of the one or more reference terminal devices which are associated with the session ID and/or transaction IDs. For example, the IDs of the one or more reference terminal devices may be sent if the ranging/positioning result needs to be calculated by the location server and if such information has not been provided before or there is an update. The IDs of the one or more reference terminal devices may be sent as a complete list or in a delta update format. With the method of FIG. 7, the determination of the positioning result by the location server can be facilitated.

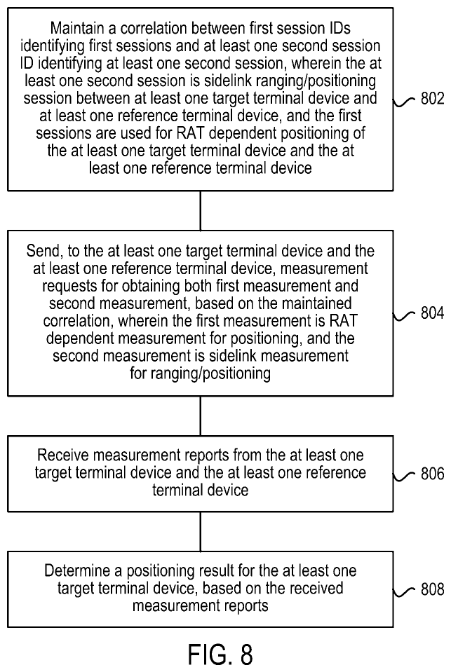

FIG. 8 is a flowchart illustrating a method performed by a location server according to an embodiment of the disclosure. The role of the location server may be implemented by an LMF, or any other entity having similar functionality. At block 802, the location server maintains a correlation between first session IDs identifying first sessions and at least one second session ID identifying at least one second session. The at least one second session is sidelink ranging/positioning session between at least one target terminal device and at least one reference terminal device. The first sessions are used for RAT dependent positioning of the at least one target terminal device and the at least one reference terminal device. For example, the first session may be a Uu session between the location server and the at least one target/reference terminal device. The at least one second session ID may be provided by the location server or one of the at least one target terminal device.

At block 804, the location server sends, to the at least one target terminal device and the at least one reference terminal device, measurement requests for obtaining both first measurement and second measurement, based on the maintained correlation. The first measurement is RAT dependent measurement (e.g. Uu measurement) for positioning. The second measurement is sidelink measurement for ranging/positioning. For example, the existing LPP protocol between the location server and the at least one target/reference terminal device may be extended to indicate that both first measurement and second measurement are required. Each of the measurement requests may comprise a same transaction ID so that the measurements from the at least one target/reference terminal device in the same hybrid session can be associated.

At block 806, the location server receives measurement reports from the at least one target terminal device and the at least one reference terminal device. Correspondingly, each of the measurement reports may comprise the same transaction ID. At block 808, the location server determines a positioning result for the at least one target terminal device, based on the received measurement reports. With the method of FIG. 8, it is possible to allow the location server to improve positioning accuracy with a hybrid session.

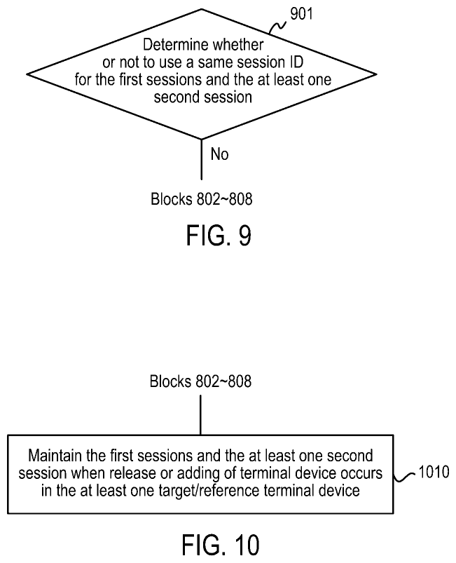

FIG. 9 is a flowchart illustrating a method performed by a location server according to an embodiment of the disclosure. As shown, the method comprises block 901 and blocks 802-808 described above. At block 901, the location server determines whether or not to use a same session ID for the first sessions and the at least one second session. If the determination result at block 901 is negative, blocks 802-808 are performed. That is, the maintaining at block 802 is performed when determining not to use a same session ID for the first sessions and the at least one second session. With the method of FIG. 9, different alternative solution can be flexibly selected for the hybrid session.

FIG. 10 is a flowchart illustrating a method performed by a location server according to an embodiment of the disclosure. As shown, the method comprises blocks 802-808 described above, and block 1010. At block 1010, the location server maintains the first sessions and the at least one second session when release or adding of terminal device occurs in the at least one target/reference terminal device. With the method of FIG. 10, an updated positioning result can be provided since the first sessions and the at least one second session are maintained in response to a change.

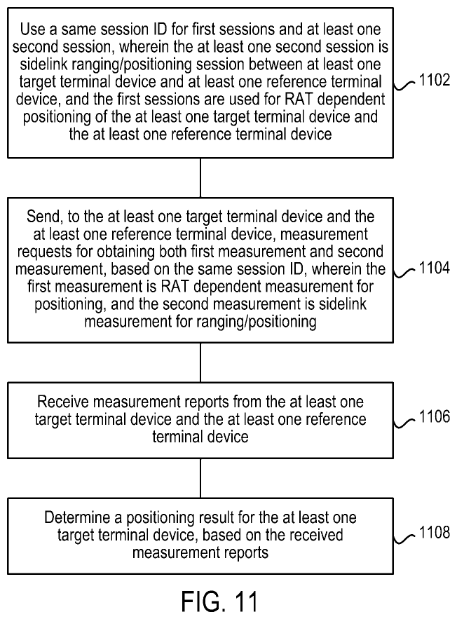

FIG. 11 is a flowchart illustrating a method performed by a location server according to an embodiment of the disclosure. The role of the location server may be implemented by an LMF, or any other entity having similar functionality. At block 1102, the location server uses a same session ID for first sessions and at least one second session. The at least one second session is sidelink ranging/positioning session between at least one target terminal device and at least one reference terminal device. The first sessions are used for RAT dependent positioning of the at least one target terminal device and the at least one reference terminal device. For example, the first session may be a Uu session between the location server and the at least one target/reference terminal device.

At block 1104, the location server sends, to the at least one target terminal device and the at least one reference terminal device, measurement requests for obtaining both first measurement and second measurement, based on the same session ID. The first measurement is RAT dependent measurement (e.g. Uu measurement) for positioning. The second measurement is sidelink measurement for ranging/positioning. For example, the existing LPP protocol between the location server and the at least one target/reference terminal device may be extended to indicate that both first measurement and second measurement are required. Each of the measurement requests may comprise a different transaction ID so that the first sessions can be differentiated with each other. For example, the different transaction IDs sent to different terminal devices may be from different ranges of values.

At block 1106, the location server receives measurement reports from the at least one target terminal device and the at least one reference terminal device. Correspondingly, each of the measurement reports may comprise the corresponding different transaction ID. At block 1108, the location server determines a positioning result for the at least one target terminal device, based on the received measurement reports. With the method of FIG. 11, it is possible to allow the location server to improve positioning accuracy with a hybrid session.

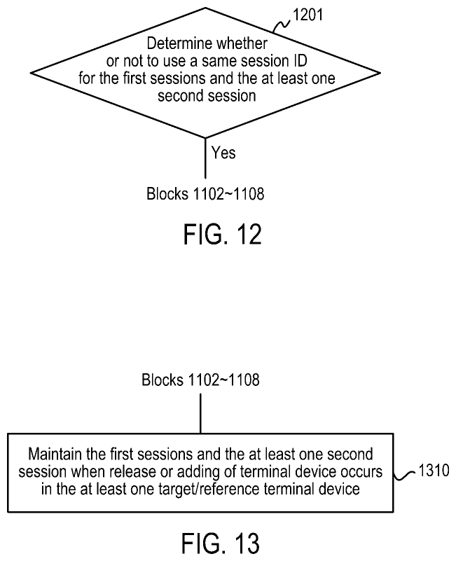

FIG. 12 is a flowchart illustrating a method performed by a location server according to an embodiment of the disclosure. As shown, the method comprises block 1201, and blocks 1102-1108 described above. At block 1201, the location server determines whether or not to use a same session ID for the first sessions and the at least one second session. If the determination result at block 1201 is positive, blocks 1102-1108 are performed. That is, the same session ID is used when determining to use a same session ID for the first sessions and the at least one second session. With the method of FIG. 12, different alternative solution can be flexibly selected for the hybrid session.

FIG. 13 is a flowchart illustrating a method performed by a location server according to an embodiment of the disclosure. As shown, the method comprises blocks 1102-1108 described above, and block 1310. At block 1310, the location server maintains the first sessions and the at least one second session when release or adding of terminal device occurs in the at least one target/reference terminal device. With the method of FIG. 13, an updated positioning result can be provided since the first sessions and the at least one second session are maintained in response to a change.

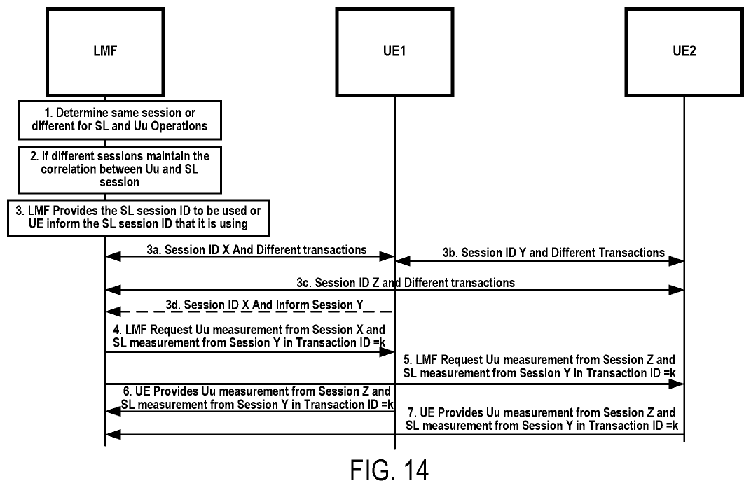

FIG. 14 is a flowchart illustrating an exemplary process according to an embodiment of the disclosure. In this process, a new session identifier is used to indicate/associate the measurement from reference UE(s) (and target UE(s)) which are within a single ranging/SL positioning session. Different Session IDs (for SL and Uu Operation) are used and the Session IDs are correlated by an LMF.

The prerequisite is that the LMF determines to perform hybrid measurements using Uu and SL measurements. Uu measurements are the measurements obtained from RAT dependent positioning method such as RSTD, TDOA, Rx−Tx differences, RSRP, etc. which is based upon UE and NW (e.g. gNB). SL measurements are the measurements based upon UE to UE and the measurements are RTT, SL-TDOA, SL Rx−Tx differences, etc. The reason to perform hybrid measurements is to improve positioning accuracy, if the UE happens to be in non-line-of-sight (NLOS), to compute the range between UEs, etc.

At step 1, the LMF determines whether to use different session IDs or a same session ID for SL and Uu operations. At step 2, if the LMF determines to use different session IDs, the LMF maintains the correlation between Uu (LPP session) and SL session (SLPP session) IDs. “Correlate” here implies to keep track and bind/associate the Uu (LPP Session NW to UE) and SL session IDs (SLPP UE to UE). For example, the LMF should be able to receive the Uu measurement and SL measurement from the UEs with the same transaction ID.

At step 3, the LMF provides the SL session ID to be used or the UE informs the SL session ID that it is using. The LMF uses different sessions for Uu operations. The LMF also requests the UEs to perform SL measurements and provides assistance data (AD) for SL and optionally the session ID. The UE may optionally provide the SL session ID. That is, the session ID may be created by the target UE or LMF/SL UE server.

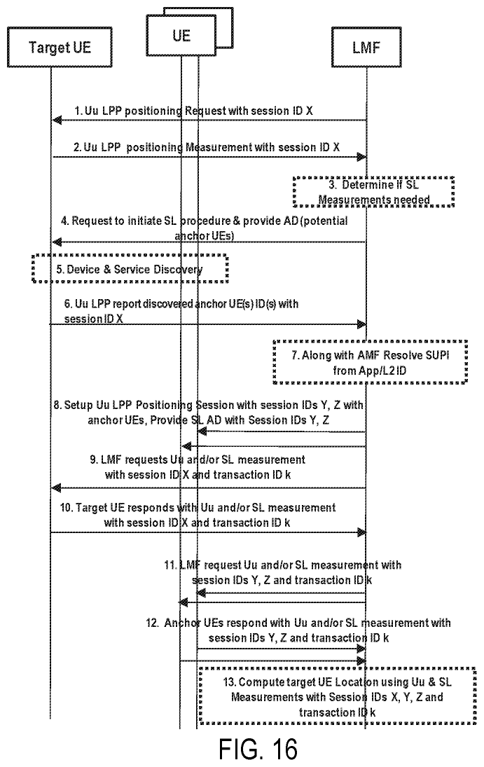

At step 4 and step 5, the LMF requests the UE to provide both Uu and SL measurements using a transaction ID that it can correlate a number of measurements that have taken place at the same time frame. At step 6 and step 7, the obtained measurements are fused to obtain the range between UEs or to precisely locate the UEs. Note that the LMF is the responsible node for maintaining the session when for example one of the UE is released. Also note that FIG. 14 shows the session ID & transaction impacts. The actual procedure/steps as described in FIG. 16 captures the complete steps needed.

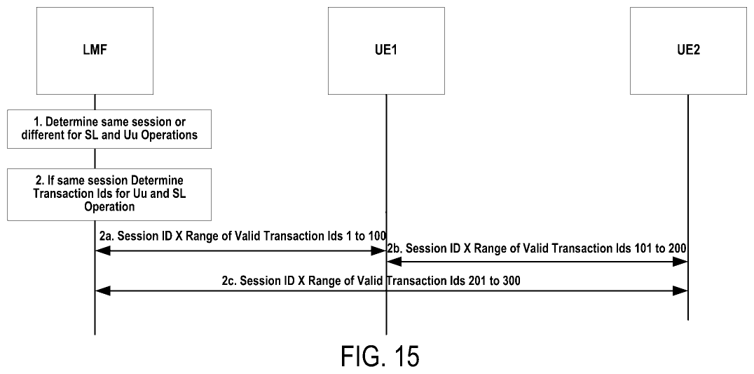

FIG. 15 is a flowchart illustrating an exemplary process according to an embodiment of the disclosure. In this process, the LMF determines to use same session and differentiate with different transaction IDs. At step 1, the LMF determines whether to use different session IDs or a same session ID for SL and Uu operations. At step 2, if the LMF determines to use a same session for Uu and SL operations, the LMF and UEs maintain the same session but differentiate the message exchange using different set of transaction IDs. The LMF may provide AD for Uu measurements and to perform SL measurements.

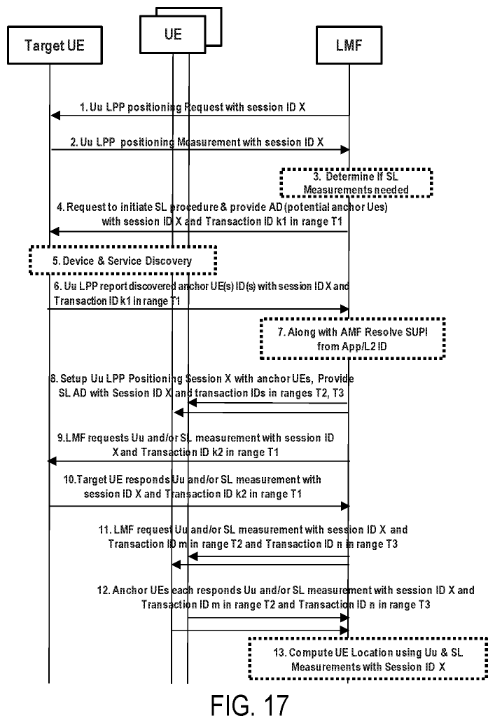

Subsequently, the LMF obtains the SL measurement results and Uu measurement or location results from the UE. The LMF combines the measurement and location information to accurately position the UE or to estimate the range between two UEs. Note that the LMF is the responsible node for maintaining the session when for example one of the UE is released. Also note that FIG. 15 shows the session ID & transaction impacts. The actual procedure/steps as described in FIG. 17 captures the complete steps needed.

FIG. 16 is a flowchart illustrating an exemplary process according to an embodiment of the disclosure. This process corresponds to hybrid positioning session with different session IDs. At step 1, a Uu LPP positioning request with session ID X is either sent from an LMF to a target UE. At step 2, the target UE reports Uu measurement to the LMF with session ID X. At step 3, based on the Uu measurement from the target UE in step 2, the LMF decides if SL measurement is needed. If not needed, the LMF calculates the target UE's position. If needed, the process continues to below steps.

At step 4, the LMF sends a request to the target UE to initiate SL procedure & provide AD (potential anchor UEs). At step 5, the target UE discovers anchor UEs. At step 6, the target UE reports discovered anchor UE(s) ID(s) to the LMF using Uu LPP. At step 7, along with an AMF, the LMF resolves SUPI of the anchor UEs from their App/L2 ID. At step 8, the LMF sets up Uu LPP Positioning Session with session IDs Y, Z with anchor UEs, Provide SL AD with Session IDs Y, Z.

At step 9, the LMF requests the target UE to perform Uu and/or SL measurement with session ID X and transaction ID k. At step 10, the target UE responds to the LMF with Uu and/or SL measurement with session ID X and transaction ID k. At step 11, the LMF requests the anchor UEs to perform Uu and/or SL measurement with session IDs Y, Z and transaction ID k. At step 12, the anchor UEs respond to the LMF with Uu and/or SL measurement with session IDs Y, Z and transaction ID k. At step 13, the LMF computes target UE Location using Uu & SL Measurements with Session IDs X, Y, Z and transaction ID k.

FIG. 17 is a flowchart illustrating an exemplary process according to an embodiment of the disclosure. This process corresponds to a hybrid positioning session with same session ID but different sets of transaction IDs. At step 1, a Uu LPP positioning request with session ID X is either sent from an LMF to a target UE. At step 2, the target UE reports Uu measurement to the LMF with session ID X. At step 3, based on the Uu measurement from the target UE in step 2, the LMF decides if SL measurement is needed. If not needed, the LMF calculates the target UE's position. If needed, the process continues to below steps.

At step 4, the LMF sends a request to the target UE to initiate SL procedure & provide AD (potential anchor UEs) with session ID X and Transaction ID k1 in range T1. At step 5, the target UE discovers anchor UEs. At step 6, the target UE reports discovered anchor UE(s) ID(s) to the LMF using Uu LPP with session ID X and Transaction ID k1 in range T1. At step 7, along with an AMF, the LMF resolves SUPI of the anchor UEs from their App/L2 ID. At step 8, the LMF sets up Uu LPP Positioning Sessions and provides SL AD with anchor UEs with Session ID X and Transaction IDs in ranges T2, T3 respectively.

At step 9, the LMF requests the target UE to perform Uu and/or SL measurement with session ID X and Transaction ID k2 in range T1. At step 10, the target UE responds to the LMF with Uu and/or SL measurement with session ID X and Transaction ID k2 in range T1. At step 11, the LMF requests the anchor UEs to perform Uu and/or SL measurement with session ID X and Transaction ID m in range T2 and Transaction ID n in range T3. At step 12, the anchor UEs respond to the LMF with Uu and/or SL measurement with session ID X and Transaction ID m in range T2 and Transaction ID n in range T3. At step 13, the LMF computes target UE Location using Uu & SL Measurements with Session ID X.

Now, several embodiments will be further described to explain the principle of the present disclosure. In an embodiment, a ranging/SL positioning session ID can be used to identify a SL positioning session with target UE(s), reference UE(s) and a location server.

With the proposed ranging/SL positioning session ID, it can clearly indicate that the measurements are associated with a specific ranging/SL positioning session or a hybrid session.

In another embodiment, the SL positioning measurement report carries session ID to indicate that the measurements are associated with a specific ranging/SL positioning session along with the Uu measurements.

### With Respect to a Separate Session ID Solution

In an embodiment, a method performed by a location server node is provided to determine whether a common SL session and Uu session is to be configured or separate session needs to be configured

In another embodiment, a method performed by a location server node is provided to associate/correlate Uu session ID and SL Session ID where separate session IDs are allocated.

In another embodiment, a method performed by a location server node is provided to obtain the SL Session ID information from a UE where separate session IDs are allocated.

In another embodiment, a method performed by a location server node is provided to allocate the SL Session ID information to a UE where separate session IDs are allocated.

In another embodiment, a method performed by a location server node is provided where separate session IDs are allocated to request multiple UEs location or measurement for both the Uu and SL sessions using the same transaction ID.

### With Respect to a Same Session ID Solution

In an embodiment, a method performed by a location server node is provided where a common session ID is allocated for Uu and SL session.

In another embodiment, a method performed by a location server node is provided where a common session ID is allocated for Uu and SL session and the differentiation is performed with respect to allocating different transaction IDs.

### With Respect to a Mixed Solution

In an embodiment, a method performed by a location server node is provided where the Uu and SL sessions are maintained by the location server when UEs are released or added.

In another embodiment, one of the UEs involved in SL ranging or Uu operation can be PRU.

### Ranging/SL Positioning Session

In an embodiment, a ranging/SL positioning session is used between target UE(s), reference UE(s) and a location server in order to obtain: ranging/location related measurements; or a ranging/location estimate; or to transfer assistance data.

In another embodiment, a single ranging/SL positioning session is used to support a single ranging/location request.

In another embodiment, depending on the entity that initiates the ranging/SL positioning session, the session ID is created by a target UE or an LMF. For example, the session ID MO-LR ranging/SL positioning is created by the target UE; and the session ID MT-LR ranging/SL positioning is created by the LMF.

In another embodiment, once the ranging/SL session ID is created, it is communicated to other participants in this session.

### Session ID Created by a Target UE and Provided to an LMF

In an embodiment, when the session ID is created by the target UE and if ranging/SL positioning results are to be calculated by a location server (either the LMF or an SL UE server), the target UE sends the session ID in the ranging/SL positioning request to the location server. In the ranging/SL positioning request, the target UE also indicates if there are other target UE(s) and/or discovered UE(s) as potential reference UE(s) for this session.

In another embodiment, if ranging/SL positioning results are to be calculated by the location server (LMF/SL UE server), the target UE indicates the involved reference UE ID associated with the session ID to the server if such information has not been sent or there is an update.

For example, the reference UE(s) information in a session may be in a diff format or complete list.

### Session ID Created by an LMF

In an embodiment, when the session ID is created by the LMF, the LMF sends the session ID in the ranging/SL positioning request to target UE(s).

As an optional step, an LMF/SL UE server can indicate its preferred reference UE(s) for the target UE to discover, which are associated with a specific session by the session ID.

With respect to session ID used by the Target UE and Reference UEs, the session ID may be sent to other involved target UE(s) and/or reference UE(s) via PC5 message by the target UE or via LPP or LPP extension between the UE and the LMF by the LMF.

In an embodiment, the target UE or the LMF includes the session ID in the measurement request sent to target UE(s) and/or reference UE(s).

In an embodiment, target UE(s) and/or reference UE(s) include the associated session ID when sending a measurement report.

In an embodiment, the ranging/SL positioning session ID range [X, Y) (Y is a different integer with X) may be divide into different non-overlapping subsets, and each subset is mapped to different cases of the entity that collects the measurement and calculates the results. For example, the whole the ranging/SL positioning session ID range [X, Y) is divided to [X, M) and [M, Y) (X, M, Y are three integers in an increasing or decreasing order). A session ID is within [X, M) indicates that the target UE collects measurement and calculates the results, and a session ID is within [M, Y) indicates that the location server collects measurement and calculates the results. It may further differentiate between the LMF and the SL UE server by dividing [M, Y) into 2 subsets further.

In another embodiment, the ranging/SL positioning session ID range X with transaction IDs [Y, Z) (Y is a different integer with Z) may be divided into different non-overlapping subsets, and each subset is mapped to different cases of the entity that collects the measurement and calculates the results. For example, the whole the ranging/SL positioning session ID X transaction ID range [Y, Z) is divided to [Y, M) and [M, Z) (Y, M, Z are three integers in an increasing or decreasing order). For a session ID X with different transaction IDs are within [Y, M) indicates that the target UE collects measurement and calculates the results, and a transaction ID is within [M, Y) indicates that the location server collects measurement and calculates the results. It may further differentiate between the LMF and the SL UE server by dividing [M, Y) into 2 subsets further.

In another embodiment, for a ranging request of two UEs, if the two UEs are two far apart to perform ranging, the LMF can initiate separate absolute positioning measurements for the two UEs and calculate the ranging results. For such scenario, when sending the ranging results, the LMF also indicates that the ranging result is based on absolute positioning instead of ranging measurements or hybrid ranging measurements.

Based on the above description, the following changes are proposed to be made to 3GPP TS 37.355, where the changes are highlighted with underlines.

### 4.1.2 LPP Sessions and Transactions

An LPP session is used between a Location Server and the target device in order to obtain location related measurements or a location estimate or to transfer assistance data. A single LPP session is used to support a single location request (e.g., for a single MT-LR, MO-LR or NI-LR). Multiple LPP sessions can be used between the same endpoints to support multiple different location requests (as required by TS 23.271 [3]). In ranging/SL positioning, there are cases when multiple LPP sessions with different devices are used to support a single ranging/SL positioning request, and an LMF is responsible to associate the measurements from relevant sessions and compute the result. Each LPP session comprises one or more LPP transactions, with each LPP transaction performing a single operation (capability exchange, assistance data transfer, or location information transfer). In E-UTRAN and NG-RAN, the LPP transactions are realized as LPP procedures. The instigator of an LPP session will always instigate the first LPP transaction, but subsequent transactions may be instigated by either end. LPP transactions within a session may occur serially or in parallel. LPP transactions are indicated at the LPP protocol level with a transaction ID in order to associate messages with one another (e.g., request and response).

Messages within a transaction are linked by a common transaction identifier.

Furthermore, the following observations and proposals are provided.

### 1. Introduction

The work items for SL in RAN2 include:
Specify signalling and associated UE behavior for support of unicast, groupcast (not including many to one) and broadcast of SL PRS transmissions [RAN1, RAN2].
Specify reporting signalling and procedures to facilitate support of SL positioning in all coverage scenarios and for PC5-only and joint PC5-Uu scenarios [RAN2, RAN3]:
   Specify the protocol and procedures for SL positioning between UEs (Protocol for Sidelink positioning procedures (SLPP)).
   Specify the protocol and procedures for SL positioning between UEs and an LMF.
      In this document, we discuss the potential signalling procedures for LPP extension to support SL ranging/positioning. 1) Hybrid Positioning with LPP Extension 2) SLPP protocol Stack Discussion 3) Discovery Procedure 4) Overhearing.

### 2. Discussion

### 2.1 Hybrid Positioning with LPP Extension

There are different use cases which require an LMF to perform hybrid positioning such as a request from an external client to be able to provide the range between two UEs or improve the UE positioning accuracy with assistance from another UE such as reference UE/PRU. For ranging determination, to improve the reliability and accuracy of range estimation; the LMF can perform hybrid positioning such as obtain the absolute UE location (using Uu (UE and NW) measurements) and also range estimation between UEs SL measurements.

For SL ranging/positioning, signalling procedures including capability exchange, reference UE selection, assistance data transfer, ranging/sidelink positioning measurement, report and calculation are needed. For IC scenario, the LMF can collect and provide the above IEs to calculate the requested ranging/positioning results as in LPP. Such signalling procedures are similar to the LPP procedures, it is natural to extend LPP with signalling procedures for SL ranging/positioning.

Observation 1: LPP session should be extended such that multiple UEs can join the positioning session with the LMF and allow the LMF to perform hybrid Positioning. LPP with signalling procedures for SL ranging/positioning which is used at Uu interface between the LMF and the UE should also support SL UE to UE operations.

### 2.1.1 Extended LPP Session for Ranging/SL Positioning

There can be below two Options on how LPP session can be extended to accommodate SL operations. Option1: A common LPP session to have multiple target devices. Transaction ID range to different target devices are set to different range in order not to collide. Option2: Multiple LPP sessions each with one individual device are used to support a single ranging/SL positioning request. The association between SL session and Uu session has to be maintained by the LMF. Option 2 has less impact to the legacy LPP. FIG. 17 illustrates an example extended LPP session procedure with Option 1. FIG. 16 illustrates an example extended LPP session procedure with Option 2.

In above examples, apart from Uu operation, there has to be sidelink operations between UEs and also one of the UEs can be a reference UE/PRU. We see the steps needed are:
An LMF should be able to establish LPP session with UEs and configure SLPP configuration between UEs (considering they are in same cell or area); Or
A target UE should be able to convey to the LMF that it has discovered a PRU.
The LMF should be able to resolve SL L2/Application ID of PRU to SUPI and establish LPP session for Uu measurements.
The LMF should be able to setup Uu positioning with the target UE and the PRU.
The LMF should be able to provide SL AD or request to a gNB to allocate resource and provide configuration for SL-PRS configuration.
The LMF should be able to obtain both SL measurements and Uu measurements from multiple UEs.

Proposal 1: LPP session between the UE and the NW is extended to support UE to UE SL Operations and to allow the LMF to execute hybrid Positioning procedures by obtaining Uu and SL measurements.

Proposal 2: The target UE shall discover a reference UE/PRU and report to the LMF and the LMF setups LPP positioning session with the reference UE/PRU and SL session between reference and target UEs.

Proposal 3: The LMF setups LPP positioning session with multiple UEs and SL session among multiple UEs and obtains both Uu and SL measurements.

Proposal 4: Send LS to SA2 on how PRU SL ID can be resolved to SUPI so that the LMF can initiate positioning towards such UE.

To implement SL ranging/positioning, discovery procedure is needed to establish PC5 path, thus the LMF should be able to retrieve ProSe Capability from an AMF if stored, or directly request ProSe Capability from a UE. For SL ranging/positioning, the UE capability to transmit SL-PRS, measure and calculate for each detailed SL ranging/positioning method such as RTT, SL-TDOA should also be defined and supported by LPP.

Proposal 5: LPP should support to request and provide 5G ProSe Capability.

Proposal 6: The PC5 Capability for Ranging/SL positioning should be defined, and LPP should support to request and provide PC5 Capability for Ranging/SL positioning.

### 2.2 LMF to UE Protocol Support for Sidelink

The TR 38.859 contains below Options for protocol support for Sidelink between an LMF and a UE:
Extension of LPP, whereby new signaling is to be defined to support hybrid Uu and PC5 based positioning, i.e., extend the existing LPP to support sidelink based positioning between the UE and the LMF.
Enhancement of LPP whereby SLPP signaling can be transported within LPP transparently, i.e., use the newly defined SLPP to support sidelink based positioning and use the existing LPP to support Uu based positioning; and the SLPP is carried as a container in LPP.
Use of SLPP between the UE and the LMF.

Our view is that we should follow the approach of 1st Option; i. e Extension of LPP to develop the ASN.1 for now. However, at a later stage depending upon how ASN.1 appears a decision can be made to use container or direct SLPP. Since it is easier to extend the LPP and then considering this baseline evaluate different options.

Proposal 7: The baseline for developing ASN.1 to support SL operations between the LMF and the UE is by means of extension of LPP. The decision whether to use container solution or direct SLPP between the UE and the LMF is taken after evaluating the baseline extension.

### 2.2.1 Example LPP Extension for SL

### RequestCapabilities

The RequestCapabilities message body in a LPP message is used by the location server to request the target device capability information for LPP and the supported individual positioning methods.

### SL-RTT-RequestCapabilities

The IE SL-RTT-RequestCapabilities is used by the location server to request the capability of the target device to support SL-RTT and to request SL-RTT Capabilities from a target device.

### SL-TDOA-RequestCapabilities

The IE SL-TDOA-RequestCapabilities is used by the location server to request the capability of the target device to support SL-TDOA and to request SL-TDOA Capabilities from a target device.

### SL-AoA-RequestCapabilities

The IE SL-AoA-RequestCapabilities is used by the location server to request the capability of the target device to support SL-AoA and to request SL-AoA Capabilities from a target device.

### ProvideCapabilities

The ProvideCapabilities message body in a LPP message indicates the LPP capabilities of the target device to the location server.

### SL-RTT-ProvideCapabilities

The IE SL-RTT-ProvideCapabilities is used by the target device to indicate its capability to support SL-RTT and to provide its SL-RTT for positioning capabilities to the location server.

### SL-TDOA-ProvideCapabilities

The IE SL-TDOA-ProvideCapabilities is used by the target device to indicate its capability to support SL-TDOA and to provide its SL-TDOA for positioning capabilities to the location server.

### SL-AoA-ProvideCapabilities

The IE SL-AoA-ProvideCapabilities is used by the target device to indicate its capability to support SL-AoA and to provide its SL-AoA for positioning capabilities to the location server.

### 2.2.2.2 AD Request and Provide

### RequestAssistanceData

The RequestAssistanceData message body in a LPP message is used by the target device to request assistance data from the location server.

### SL-RTT-RequestAssistanceData

The IE SL-RTT-RequestAssistanceData is used by the device to request assistance data from a location server.

### SL-RTT-RequestAssistanceData

The IE SL-TDOA-RequestAssistanceData is used by the device to request assistance data from a location server.

### SL-AoA-RequestAssistanceData

The IE SL-AoA-RequestAssistanceData is used by the device to request assistance data from a location server.

### ProvideAssistanceData

The ProvideAssistanceData message body in a LPP message is used by the location server to provide assistance data to the target device either in response to a request from the target device or in an unsolicited manner.

### SL-RTT-ProvideAssistanceData

The IE SL-RTT-ProvideAssistanceData is used by the location server to provide assistance data to enable SL-RTT.

### SL-TDOA-ProvideAssistanceData

The IE SL-TDOA-ProvideAssistanceData is used by the location server to provide assistance data to enable SL-TDOA.

### SL-AoA-ProvideAssistanceData

The IE SL-AoA-ProvideAssistanceData is used by the location server to provide assistance data to enable SL-AoA.

### 2.2.2.3 Location Information Request and Provide

### RequestLocationInformation

The RequestLocationInformation message body in a LPP message is used by the location server to request positioning measurements or a position estimate from the target device.

### SL-RTT-RequestLocationInformation

The IE SL-RTT-RequestLocationInformation is used by the location server to request SL-RTT location measurements from a device.

### SL-TDOA-RequestLocationInformation

The IE SL-TDOA-RequestLocationInformation is used by the location server to request SL-TDOA location measurements from a device.

### SL-AoA-RequestLocationInformation

The IE SL-AoA-RequestLocationInformation is used by the location server to request SL-AoA location measurements from a device.

### ProvideLocationInformation

The ProvideLocationInformation message body in a LPP message is used by the target device to provide positioning measurements or position estimates to the location server.

### SL-RTT-ProvideLocationInformation

The IE SL-RTT-ProvideLocationInformation is used by the target device to provide SL-RTT location measurements to the location server. It may also be used to provide SL-RTT positioning specific error reason.

### SL-TDOA-ProvideLocationInformation

The IE SL-TDOA-ProvideLocationInformation is used by the target device to provide SL-TDOA location measurements to the location server. It may also be used to provide SL-TDOA positioning specific error reason.

### SL-RTT-ProvideLocationInformation

The IE SL-AoA-ProvideLocationInformation is used by the target device to provide SL-AoA location measurements to the location server. It may also be used to provide SL-AoA positioning specific error reason.

### 2.3 SLPP Protocol Stack Discussion

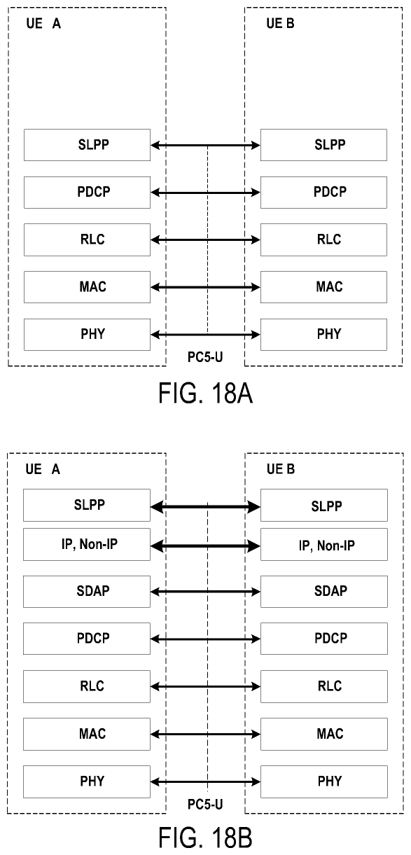

RAN2 need to decide which approach to take for placement of SLPP in the protocol stack. There are two options: Option 1) on top of PDCP as shown in FIG. 18A; Option 2) SL-DRB as shown in FIG. 18B, Similar to V2X.

### 2.4 SL Ranging Measurements when Synch Source or Coverage Changes

For SL positioning/ranging measurements, accurate synchronization is essential. A UE which has been configured to perform SL operation may move whereby the synch source may have to be changed. How would UE cope when the synch source during positioning measurement changes? Additionally, another question would be: UEs may be (pre)configured (pre-allocated resources) to perform SL ranging measurements in different coverage scenarios (IC, PC, OOC). A group of UEs (at least 2 UEs, e.g., car platooning) may perform ranging continuously; however, in the coverage crossing area (IC to OOC or vice versa) where UEs may have performed the measurement in one coverage but now happen to be in a different coverage; would the ongoing measurements be valid?

The synchronization and measurement validity are RAN4 related question which should be provided by RAN4. Depending upon the outcome of the results, the SL procedure would have impact, such as whether to continue the SL procedure or restart the procedure.

Proposal 8: Send LS to RAN 4 requesting how would the ongoing SL measurements be impacted when the synch source changes and/or coverage status changes.

### 2.5 Discovery Procedure for SL Positioning

In SL positioning, a target UE and/or anchor UE(s) transmits and/or measures SL-PRS. The target UE expected to reuse the existing ProSe discovery procedures to find potential anchor UEs. Unlike in SL communication where the discovered UE(s) is usually the designated receiver(s) to consume the SL communication message, the anchor UE(s) in SL positioning are instead expected to measure (and transmit) SL-PRS thus in this sense all the nearby UEs seem to have the potential to act as anchor UE(s). However, depending on the use case, the SL positioning/ranging sessions are imposed with different positioning QoS requirements. Such QoS requirements would further require the selected assisting UEs to be capable of providing SL transmissions or receptions according to the QoS requirement for the corresponding SL positioning/ranging sessions/services.

However, there is no mechanism to support indicating positioning QoS requirement in the current ProSe Discovery process for SL positioning/ranging, and this may lead to unsatisfied QoS with degraded positioning accuracy and/or latency, and waste of resources. For example, a target UE cannot indicate the QoS requirements of the SL positioning services/sessions to its neighbor UEs (e.g., potential anchor UEs). Without such information, its neighbor UEs would not be able to decide whether they fulfill the QoS requirements of the SL positioning sessions/services. A neighbor UE which is not suitable may provide a discovery response message to the target UE by mistake (wrong selection). The target UE may therefore select this neighbor UE as one anchor UE by mistake (wrongly). The wrong selection of anchor UE(s) may cause SL positioning QoS requirement not satisfied and/or anchor UE(s) reselection that cause resource waste and longer latency.

Observation 2: The current ProSe Discovery process does not support indicating positioning QoS requirement in for SL positioning/ranging, and this may lead to unsatisfied QoS with degraded positioning accuracy and/or latency, and waste of resources.

Proposal 9: Inform SA2 via LS that indicating positioning QoS requirement for SL positioning/ranging is supported in the ProSe Discovery process.

### 2.6 Overhearing

### 2.6.1 gNB Overhearing SL-PRS

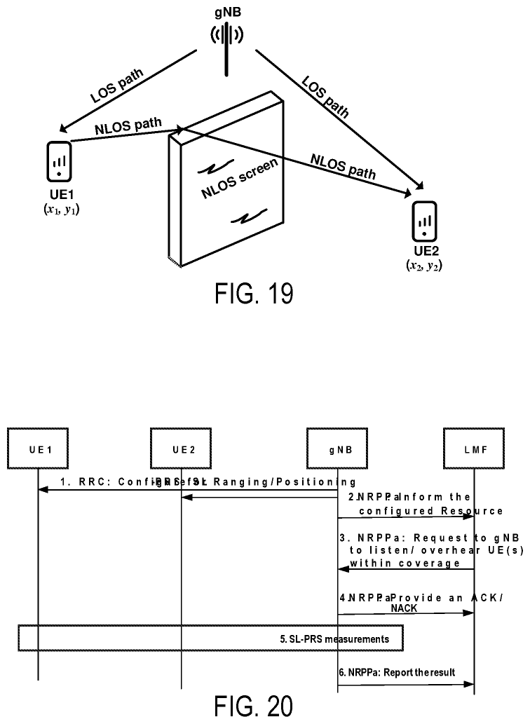

As part of the Rel-18 work item on sidelink (SL) positioning, a new SL positioning reference signal (SL-PRS) will be specified to be used for measurements between UEs. For in-coverage (IC) scenario, it would benefit if a base station is also involved in the ranging/SL positioning process with the below cases
In a ranging session the UEs have NLOS condition, and a gNB has LOS condition to the UEs as shown in FIG. 19 which illustrates an example scenario where two UEs in a ranging session are in NLOS, while the gNB has LOS condition to the UEs.
As the coverage of sidelink is limited and furthermore there may not be several UEs available to be involved for ranging measurements, then it is better the base station is involved.

For the above cases, having gNB taking measurements will improve the ranging/SL positioning accuracy. Moreover, in IC scenario SL-PRS is audible to the gNB, it is resource-efficient for the gNB to measure (overhear) on SL-PRS instead of configure UL-SRS. FIG. 4 and FIG. 5 show the mechanism of gNB overhear SL-PRS for the two resource allocation schemes respectively. From FIG. 4 when the SL-PRS is configured by the gNB, gNB overhearing SL-PRS causes no extra overhead to the UEs. In FIG. 5 when the SL-PRS is autonomously reserved by the UEs, gNB overhearing SL-PRS requires the UEs to send its SL-PRS configuration to the LMF and the gNB, which still saves more energy compared to set up Uu measurement with the gNB separately.

FIG. 20 illustrates gNB listen/overhear SL-PRS by Scheme 1. Step 1: A gNB configures SL-PRS for UE(s) within coverage for ranging or positioning purpose. The gNB may receive the request to configure such via an LMF. Step 2: The gNB reports the configured resource(s) to the LMF. Step 3: The LMF requests the gNB to measure on SL-PRS transmitted by UE(s) within coverage. Such measurements may act as extra measurements or replace SRS measurements in the multi-RTT or hybrid SL-TDOA procedures. Step 4: The gNB replies to the request by the LMF. Step 5: The gNB measures the SL-PRS transmitted by the UE(s) within coverage. Step 6: The gNB sends the measurement result(s) to the LMF.

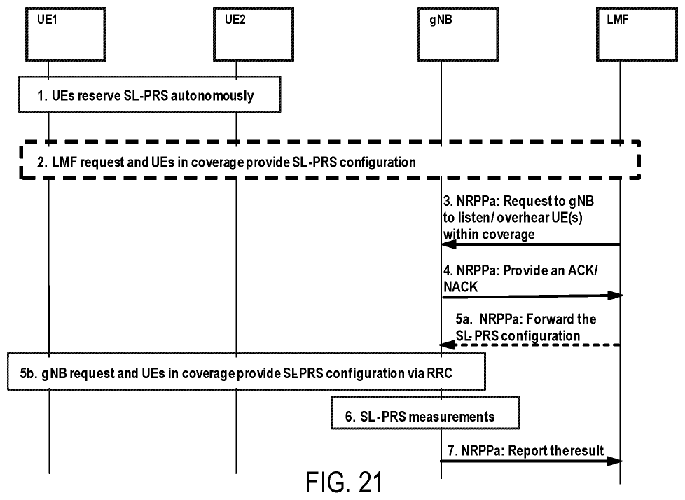

FIG. 21 illustrates gNB listen/overhear SL-PRS by Scheme 2. Step 1: UEs performing SL positioning/ranging reserve SL-PRS autonomously. Step 2: Optionally, an LMF may request for UEs that are in coverage to send their SL-PRS configuration, and the UEs provide the LMF the SL-PRS configuration. Step 3: The LMF requests a gNB to measure the SL-PRS transmitted by the UEs that is in coverage. Such measurements may act as extra measurements or replace SRS measurements in the multi-RTT or hybrid SL-TDOA procedures. Step 4: The gNB replies to the request of the LMF. Step 5: The LMF may forward the SL-PRS configuration to the gNB, or the gNB requests the UEs directly for the SL-PRS configuration. Step 6: The gNB measures SL-PRS transmitted by the UE within coverage. Step 7: The gNB sends the measurement results to the LMF.

Observation 3: gNB overhearing SL-PRS benefits the ranging/SL positioning accuracy causing no or little overhead to the UEs.

Proposal 10: gNB overhearing SL-PRS is supported.

### 3. Conclusion

Observation 1: LPP session should be extended such that multiple UEs can join the positioning session with an LMF and allow the LMF to perform hybrid Positioning. LPP with signalling procedures for SL ranging/positioning which is used at Uu interface between the LMF and the UE should also support SL UE to UE operations.

Observation 2: The current ProSe Discovery process does not support indicating positioning QoS requirement in for SL positioning/ranging, and this may lead to unsatisfied QoS with degraded positioning accuracy and/or latency, and waste of resources.

Observation 3: A gNB can compute (synthetic) range between two UEs based on absolute positioning of the two UEs. This can be used to verify or improve direct ranging between the two UEs.

Observation 4: Assistance data can be used to make an intelligent selection of anchor UEs for a target UE. This can give higher positioning performance and more efficient spectrum usage.

Observation 5: Assistance information about neighbors of a candidate anchor UE can guide the target UE to find additional anchor UEs to perform sidelink positioning measurements with.

Based on the discussion in the previous sections we propose the following:

Proposal 1: LPP session between the UE and the NW is extended to support UE to UE SL Operations and to allow the LMF to execute hybrid Positioning procedures by obtaining Uu and SL measurements

Proposal 2: The target UE shall discover a reference UE/PRU and report to the LMF and the LMF setups LPP positioning session with the reference UE/PRU and SL session between reference and target UEs.

Proposal 3: The LMF setups LPP positioning session with multiple UEs and SL session among multiple UEs and obtains both Uu and SL measurements.

Proposal 4: Send LS to SA2 on how PRU SL ID can be resolved to SUPI so that the LMF can initiate positioning towards such UE.

Proposal 7: The baseline for developing ASN.1 to support SL operations between the LMF and the UE is by means of extension of LPP. The decision whether to use container solution or direct SLPP between the UE and the LMF is taken after evaluating the baseline extension.

Proposal 8: Send LS to RAN4 requesting how would the ongoing SL measurements be impacted when the synch source changes and/or coverage status changes.

Proposal 9: Inform SA2 via LS that indicating positioning QoS requirement in for SL positioning/ranging is supported in the ProSe Discovery process.

Proposal 10: NW assisted ranging calculation based upon absolute position between two UEs is supported.

Proposal 11: Hybrid ranging involving gNBs and UEs exploiting timing advance procedures is supported.

Proposal 13: The assistance data about a candidate anchor UE can include: Sidelink positioning capabilities, state information, stationary UE indicator, UE type, Battery status, Serving cell ID and travelling path.

Proposal 14: A candidate anchor UE can provide assistance data about its neighbors, including their sidelink positioning capabilities, state information, stationary UE indicator, UE type, Battery status, Serving cell ID and travelling path. Most importantly, relative positioning information between the UEs can be included.

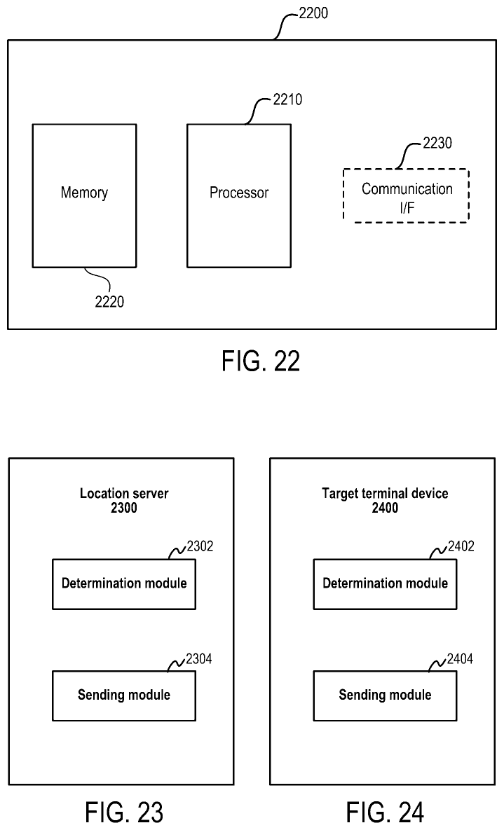

FIG. 22 is a block diagram showing an apparatus suitable for use in practicing some embodiments of the disclosure. For example, any one of the location server and the target terminal device described above may be implemented through the apparatus 2200. As shown, the apparatus 2200 may include a processor 2210, a memory 2220 that stores a program, and optionally a communication interface 2230 for communicating data with other external devices through wired and/or wireless communication.

The program includes program instructions that, when executed by the processor 2210, enable the apparatus 2200 to operate in accordance with the embodiments of the present disclosure, as discussed above. That is, the embodiments of the present disclosure may be implemented at least in part by computer software executable by the processor 2210, or by hardware, or by a combination of software and hardware.

The memory 2220 may be of any type suitable to the local technical environment and may be implemented using any suitable data storage technology, such as semiconductor based memory devices, flash memories, magnetic memory devices and systems, optical memory devices and systems, fixed memories and removable memories. The processor 2210 may be of any type suitable to the local technical environment, and may include one or more of general purpose computers, special purpose computers, microprocessors, digital signal processors (DSPs) and processors based on multi-core processor architectures, as non-limiting examples.

FIG. 23 is a block diagram showing a location server according to an embodiment of the disclosure. As shown, the location server 2300 may comprise a determination module 2302 and a sending module 2304. The determination module 2302 may be configured to determine, for one of one or more target terminal devices, a session ID for identifying a sidelink ranging/positioning session between the one or more target terminal devices, one or more reference terminal devices and the location server, and/or transaction IDs related to the sidelink ranging/positioning session. The sending module 2304 may be configured to send the session ID and/or transaction IDs to the one of the one or more target terminal devices.

FIG. 24 is a block diagram showing a target terminal device according to an embodiment of the disclosure. The target terminal device 2400 may be one of one or more target terminal devices. As shown, the target terminal device 2400 may comprise a determination module 2402 and a sending module 2404. The determination module 2402 may be configured to determine a session ID for identifying a sidelink ranging/positioning session between the one or more target terminal devices, one or more reference terminal devices and a location server, and/or transaction IDs related to the sidelink ranging/positioning session. The sending module 2404 may be configured to send the session ID and/or transaction IDs to one or more other participants in the sidelink ranging/positioning session.

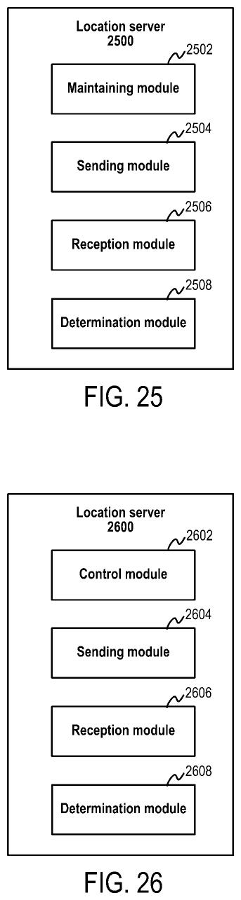

FIG. 25 is a block diagram showing a location server according to an embodiment of the disclosure. As shown, the location server 2500 may comprise a maintaining module 2502, a sending module 2504, a reception module 2506 and a determination module 2508. The maintaining module 2502 may be configured to maintain a correlation between first session IDs identifying first sessions and at least one second session ID identifying at least one second session. The at least one second session may be sidelink ranging/positioning session between at least one target terminal device and at least one reference terminal device, and the first sessions may be used for RAT dependent positioning of the at least one target terminal device and the at least one reference terminal device. The sending module 2504 may be configured to send, to the at least one target terminal device and the at least one reference terminal device, measurement requests for obtaining both first measurement and second measurement, based on the maintained correlation. The first measurement may be RAT dependent measurement for positioning, and the second measurement may be sidelink measurement for ranging/positioning. The reception module 2506 may be configured to receive measurement reports from the at least one target terminal device and the at least one reference terminal device. The determination module 2508 may be configured to determine a positioning result for the at least one target terminal device, based on the received measurement reports.

FIG. 26 is a block diagram showing a location server according to an embodiment of the disclosure. As shown, the location server 2600 may comprise a control module 2602, a sending module 2604, a reception module 2606 and a determination module 2608. The control module 2602 may be configured to use a same session ID for first sessions and at least one second session. The at least one second session may be sidelink ranging/positioning session between at least one target terminal device and at least one reference terminal device, and the first sessions may be used for RAT dependent positioning of the at least one target terminal device and the at least one reference terminal device. The sending module 2604 may be configured to send, to the at least one target terminal device and the at least one reference terminal device, measurement requests for obtaining both first measurement and second measurement, based on the same session ID. The first measurement may be RAT dependent measurement for positioning, and the second measurement may be sidelink measurement for ranging/positioning. The reception module 2606 may be configured to receive measurement reports from the at least one target terminal device and the at least one reference terminal device. The determination module 2608 may be configured to determine a positioning result for the at least one target terminal device, based on the received measurement reports. The modules described above may be implemented by hardware, or software, or a combination of both.

FIG. 23 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

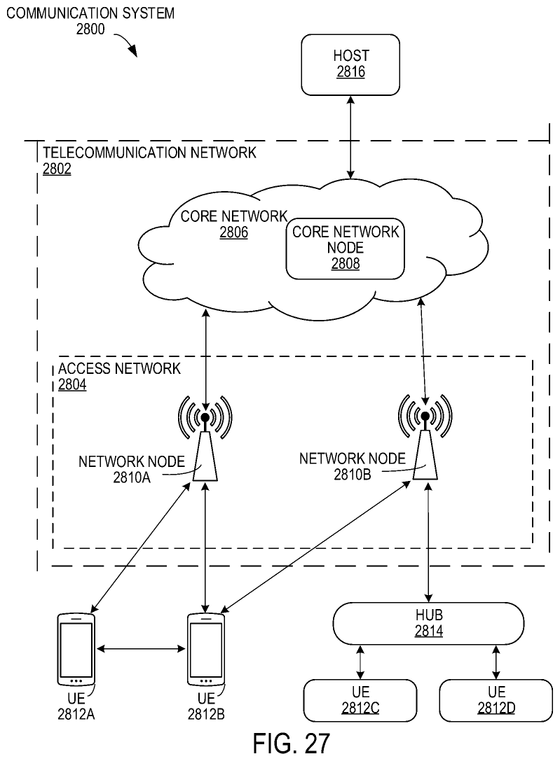

As a whole, the communication system 2800 of FIG. 27 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

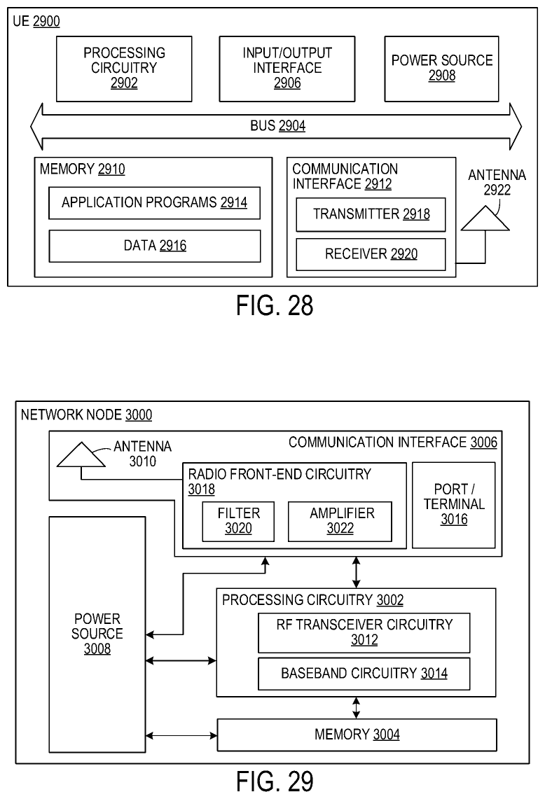

FIG. 28 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 24. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 24.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 29 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 29 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

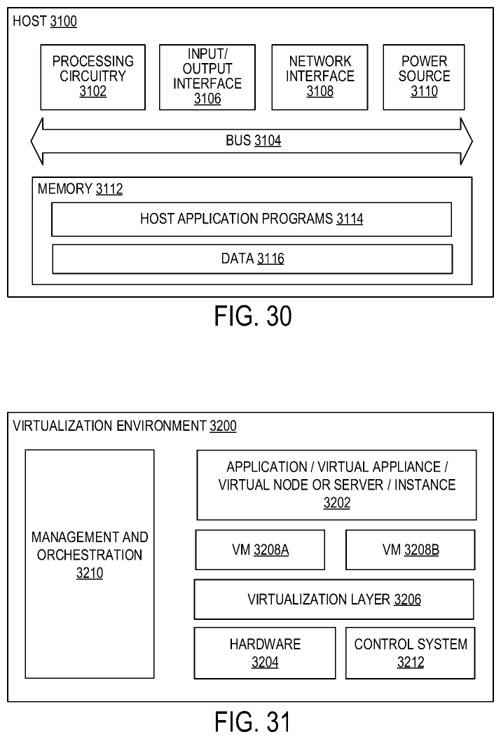

FIG. 30 is a block diagram of a host 3100, which may be an embodiment of the host 2816 of FIG. 27, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 28 and 29, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 31 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment 3200 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

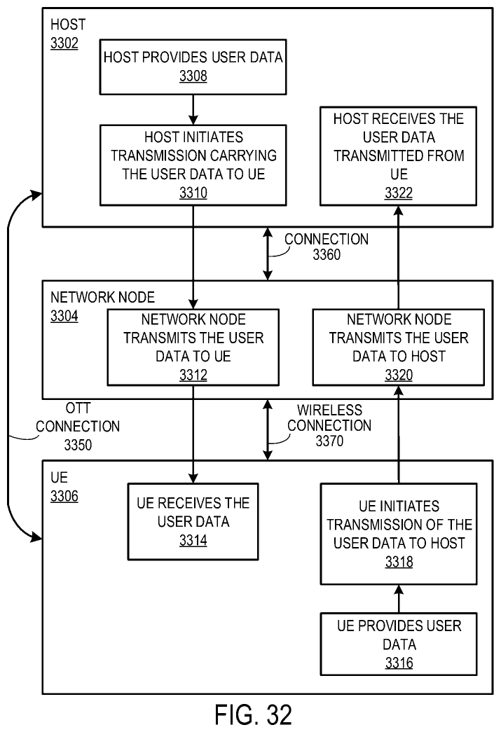

FIG. 32 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 27 and/or UE 2900 of FIG. 28), network node (such as network node 2810a of FIG. 27 and/or network node 3000 of FIG. 29), and host (such as host 2816 of FIG. 27 and/or host 3100 of FIG. 30) discussed in the preceding paragraphs will now be described with reference to FIG. 32.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 27) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the positioning accuracy and thereby provide benefits such as better user experience.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc. ; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a location server, the method comprising:
determining, for one of one or more target terminal devices, a session identifier (ID) for identifying a sidelink ranging/positioning session between the one or more target terminal devices, one or more reference terminal devices and the location server, and/or transaction IDs related to the sidelink ranging/positioning session; and
sending the session ID and/or transaction IDs to the one of the one or more target terminal devices.

2. The method of claim 1, further comprising:
sending the session ID to remaining target terminal device(s); and/or
sending the session ID to the one or more reference terminal devices.

3. The method of claim 1, wherein the session ID is determined in response to an initiation of the sidelink ranging/positioning session by the location server.

4. The method of claim 1, wherein the session ID is sent to the one of the one or more target terminal devices in a positioning request for the sidelink ranging/positioning session.

5. The method of claim 1, further comprising:
sending, to the one or more target terminal devices and/or the one or more reference terminal devices, a measurement request for the sidelink ranging/positioning session, wherein the measurement request comprises the session ID; and
receiving, from the one or more target terminal devices and/or the one or more reference terminal devices, a measurement report comprising the session ID.

6. The method of claim 1, wherein the session ID is same but differentiated by different ranges of the transaction IDs between sidelink and radio access technology dependent operation.

7. The method of claim 1, wherein the location server role is performed by one of:
a location management function network node; and
a terminal device acting as a server for sidelink positioning.

8. A method performed by a target terminal device in one or more target terminal devices, the method comprising:
determining a session identifier (ID) for identifying a sidelink ranging/positioning session between the one or more target terminal devices, one or more reference terminal devices and a location server, and/or transaction IDs related to the sidelink ranging/positioning session; and
sending the session ID and/or transaction IDs to one or more other participants in the sidelink ranging/positioning session.

9. The method of claim 8, wherein the session ID is determined in response to an initiation of the sidelink ranging/positioning session by the target terminal device.

10. The method of claim 8, wherein the session ID is sent to the location server in a positioning request for the sidelink ranging/positioning session.

11. The method of claim 10, wherein the positioning request indicates one or more of:
remaining target terminal device(s); and
one or more potential reference terminal devices which are discovered by the target terminal device.

12. The method of claim 8, further comprising:
sending, to the location server, IDs of the one or more reference terminal devices which are associated with the session ID.

13. The method of claim 8, wherein the session ID is same but differentiated by different ranges of the transaction IDs between sidelink and radio access technology dependent operation.

14. The method of claim 8, wherein the location server role is performed by:
a location management function network node, or
a terminal device acting as a server for sidelink positioning.

15-28. (canceled)

29. A target terminal device in one or more target terminal devices, comprising:
at least one processor; and
at least one memory, the at least one memory containing instructions executable by the at least one processor, wherein the target terminal device is operative to:
determine a session identifier (ID) for identifying a sidelink ranging/positioning session between the one or more target terminal devices, one or more reference terminal devices and a location server, and/or transaction IDs related to the sidelink ranging/positioning session; and
send the session ID and/or transaction IDs to one or more other participants in the sidelink ranging/positioning session.

30. The target terminal device of claim 29, wherein the session ID is determined in response to an initiation of the sidelink ranging/positioning session by the target terminal device.

31-35. (canceled)

36. The target terminal device of claim 30, wherein the session ID is sent to the location server in a positioning request for the sidelink ranging/positioning session.

37. The target terminal device of claim 29, wherein the positioning request indicates:
remaining target terminal device(s); and/or
one or more potential reference terminal devices which are discovered by the target terminal device.

38. The target terminal device of claim 29, wherein the target terminal device is operative to send to the location server IDs of the one or more reference terminal devices which are associated with the session ID.

39. The target terminal device of claim 29, wherein the location server role is performed by:
a location management function network node, or
a terminal device acting as a server for sidelink positioning.
